(19) United States
(12) Patent Application Publication
(10) Pub. No.: US 2015/0212502 A1
(43) Pub. Date: Jul. 30, 2015

(54) Determining a Controller Performance Measure

(71) Applicant: Selvanathan Sivalingam, Trondheim (NO)

(72) Inventor: Selvanathan Sivalingam, Trondheim (NO)

(21) Appl. No.: 14/604,721

(22) Filed: Jan. 24, 2015

(30) Foreign Application Priority Data
Jan. 24, 2014 (EP) 14152501.4

(51) Int. Cl. G05B 15/02

(52) U.S. Cl. CPC G05B 15/02

(57) ABSTRACT

A performance measure of a second controller adapted to control a system is determined. First system input data and first system output data are obtained, while a first controller receives the first system output data and supplies first controller output to the system as the first system input data. A system delay is estimated between the first system input data and the first system output data using a Hilbert transform relations method. Second system output data is obtained, while the second controller receives a difference between second system output data and reference data and supplies second controller output to the system as second system input data. A minimum system output variance is estimated based on the estimated system delay and an impulse response of the system. The performance measure is estimated based on the estimated minimum system output variance and a variance of the second system output data.

This application claims the benefit of EP 14152501.4, filed on Jan. 24, 2014, which is hereby incorporated by reference in its entirety.

### FIELD

The present embodiments relate to determining a performance measure of a controller.

### BACKGROUND

Estimation of the most famous control loop performance measure, Harris index, needs a priori information on the system time delay that is not known. Thereby, conventional methods to determine a control loop performance measure may involve setting different system delays by trial and error and use these to calculate a number of Harris indices from which the lowest may be selected to represent a true estimation of the control loop performance measure. However, this is very cumbersome and time-consuming and also requires high computational efforts. For example, it may be a usual practice to assume a range of time delay values in a diophantine equation while estimating minimum variance from routine operating data. Hence, according to the conventional methods and systems, an accurate measure that relates to control loop performance using minimum variance may not be found.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a method and an arrangement for determining a performance measure of a controller configured to control a system that requires less computational efforts, is simpler, and requires less computational time compared to a conventional method are provided.

According to an embodiment, a method for determining a performance measure of a controller (e.g., a second controller, a PI controller, a PID controller or the like) configured to control a system (e.g., physical system; system in which a temperature is to be maintained according to a reference temperature) is provided. The method includes obtaining first system input data and first system output data, while a first controller receives the first system output data and supplies first controller output to the system as the first system input data. The first controller includes a relay controller. The method also includes estimating a system delay between the first system input data and the first system output data using a Hilbert transform relations method based on the first system input data and the first system output data. The method includes obtaining second system output data, while the second controller receives a difference between second system output data and reference data and supplies second controller output to the system as second system input data. The method also includes estimating a minimum system output variance based on the estimated system delay and an impulse response of the system, and estimating the performance measure based on the estimated minimum system output variance and a variance of the second system output data.

The second controller may also be referred to as a normal operation controller, and the first controller may also be referred to as a relay controller.

The system may represent any technical system or technical process that, upon providing input data, produces some output data. The input data and/or the output data (e.g., electrical and/or optical signals) may, for example, be scalar values changing with time or may, for example, be or include one or more components, such as representing vector quantities, which may change with time. For example, the system may include a heater or pump that, upon providing the input data (e.g., control data to control the heater or the pump), generates a particular temperature value, pressure value, or flow rate value of a substance that is output as the output data.

When supplying a particular input data to the system (e.g., a control signal), the system may take a particular time interval or time span (e.g., the system delay) in order to affect the output data (e.g., a temperature change or a pressure change or a flow rate change). Thereby, for example, when controlling the system is required or desired, in order to achieve an output value or output data corresponding to reference data, the system delay may be required to be known. The system delay may be required to be known in order to configure or tune a controller that may generate the input signal depending on an error signal that may be a difference between the system output and a reference value under normal operating conditions. For example, the reference value may represent a desired temperature, a desired pressure, a desired flow rate, a desired frequency or any other physical quantity that may be produced or influenced by the system when the input data is supplied to the system.

For example, the system may relate to a pharmaceutical process, a physical process, a chemical process, a biological process, an electro/mechanical process or any other technical process. For example, the process may relate to an offshore process, where one or more pumps may be controlled, and one or more compressors may be controlled in order to achieve a particular pressure, a particular flow rate, a particular temperature, etc. of a fluid, such as oil or gas.

The relay controller may be a particular controller (e.g., electronic circuit or programmable arithmetic/logical processor) that may selectively output two different output signal values (e.g., according to two states), one being a signal (e.g., ‘h’) above a reference or nominal signal (e.g., a constant signal) and the other being a signal (e.g., ‘−h’) below the nominal signal (e.g., a constant signal). For example, the nominal signal may be zero or may represent zero.

In a first configuration during the method for obtaining the first system input/output data, the relay controller may supply the signal corresponding to the first state (e.g., representing a fixed signal strength or signal magnitude to the system as the first system input data). Based on the first system input data, the system may generate the first system output data, such as a particular pressure value, a particular temperature value, a particular flow rate value, a particular frequency, etc., depending on the application and the system. The first system output data may be fed back to the relay controller, which may receive the first system output data as an input. When the first system output data is above a nominal output signal, the relay controller may not change the first system input data that is supplied to the system but may keep the first system input data to the system constant. However, when the first system output data falls below the nominal output value or output quantity, the relay controller may change the first system input data supplied to the system to switch to the second state (e.g., a particular signal magnitude or signal strength below the nominal input data).

Thereby, the relay controller may sense when the first system output data output from the system crosses a particular border, such as a nominal output value. When this crossing of the first system output data occurs, the relay controller may switch the first system input data to alternate between the two states. Thereby, the switching of the first system input data may be dependent on the delay the system is introducing. Thereby, the relay controller may automatically adjust the oscillation frequency of the first system input signal being represented by the switching of the first system input signal between the two states (e.g., a state having a signal magnitude above a nominal input value and another state having a signal strength or magnitude below a nominal magnitude) such that the oscillation frequency complies with the system delay.

Process input and output data may be collected under two conditions (e.g., in the first configuration, under a relay-based tune mode, in order to obtain the first system input data and the first system output data and a second mode or configuration for obtaining the second output data). The system is set under routine operating conditions (e.g., where the second controller is arranged upstream of the system). The system outputs the second system output data, and the difference between the second system output data and the reference data is supplied to the second controller which thereupon outputs second controller output that is fed to the system as the second system input data.

In the first mode or configuration, the first controller (e.g., including a relay controller) is arranged upstream of the system and provides as the first controller output the first system input data to the system. The system outputs the first system output data that is fed as input to the first controller.

In the first mode, where the first controller is arranged upstream of the system, the system delay is estimated. Further, in the second mode, where the second controller is arranged upstream of the system, the minimum system output variance that has been estimated in the first mode is estimated using the system delay. The performance measure is estimated using the estimated minimum system output variance and a variance of the second system output data (e.g., an actual variance of the system output data under normal operation conditions).

Obtaining the first system input data and the first system output data in the first mode or configuration may, for example, be performed when an equilibrium has been reached such that the first system input data is switched with a particular frequency that may have been evolved depending on the system delay produced by the system.

The first/second system input/output data may be measured, estimated, or obtained in another manner. For example, the input/output data or the system input/output data obtained within the first mode by using the relay-based autotuning method is used to estimate the system time delay using Hilbert transform relations. Subsequently, the value of the time delay may be used in a Diophantine equation to estimate the minimum variance and therefrom, to estimate the Harris index. Based on the values of the Harris index, poorly performing control loops (e.g., second controllers) may be identified and immediately considered for route course diagnosis. Although relay-based autotuning methods may in practice be for more than two decades, the data obtained from this has not been used for ranking of control loops.

According to one or more of the present embodiments, the performance measure may be used to rank control loops based on performance of the control loops in a simple manner. Furthermore, an arrangement or tool for performance assessment of control loops may be provided by one or more of the present embodiments.

The impulse response may be represented by system output data when an impulse is provided as input data. An impulse of input data may, for example, be represented as a single occurrence of a logical one in a sequence of logical values that are all zero except the single one.

Knowledge of the system delay as estimated using the Hilbert transform relations may enable the discarding of particular coefficients representing an expansion of the impulse response. Thereby, the minimum system output variance may be estimated.

According to an embodiment, the performance measure includes a Harris Index as a ratio between the estimated minimum system output variance and the variance of the second system output data.

The Harris index may be a reliable index for assessing a performance of a control loop (e.g., the second controller).

According to an embodiment, estimating the minimum system output variance includes fitting an autoregressive exogeneous model to the impulse response of the system, to obtain impulse response coefficients. Squares of the impulse response coefficients are summed up to a coefficient associated with the estimated system delay.

The autoregressive exogeneous model (ARX) model may relate the system output to a sum of values of previous input samples. The fitting may be performed in a z-transform-domain. One or more of the present embodiments may take advantage of the time-shift property of the z-transform, as is known in the art.

According to an embodiment, the impulse response is obtained by supplying an impulse input (e.g., in a form of a delta peak) as input to the system. While obtaining the impulse response, a particular input is supplied to the system without controlling the system with the first controller or with the second controller, and the system is thus uncontrolled. In discrete terms, the delta peak may be represented as a sequence of logical false values having only a single logical true value.

According to an embodiment, the Hilbert transform relations method includes estimating from the second input data and the second output data a transfer function associated with the system. The transfer function describes the effect of the system on the second input data to result in the second output data. A first phase spectrum is determined as the phase of the estimated transfer function. A second phase spectrum is determined based on an absolute value of the estimated transfer function. An extreme of an objective function is found to obtain the system delay. The objective function depends on a difference between the first phase spectrum and the second phase spectrum.

For details of the Hilbert transform relations method, EP 13 153 101.4, filed 29 Jan. 2013 is referred to.

The transfer function (e.g., complex valued, having, for a given frequency, a real value and an imaginary value) may also be referred to as a response function describing the action of the system depending on the input data to produce the output data. The transfer function as well as the first phase spectrum and the second phase spectrum may be defined in a frequency space (e.g., a space that may be obtained from a time domain space by Fourier transformation). Further, the transfer function may be estimated across a number of frequencies (e.g., across a particular frequency range). The frequency range may, for example, be depending on a frequency of the input data when the equilibrium has been reached, as is explained above.

The first phase spectrum may include information regarding the delay introduced by the system, while the second phase spectrum will not contain any information regarding the delay introduced by the system, since the second phase spectrum may be obtained from a Hilbert transform of the amplitude spectrum. Thereby, forming a difference between the first phase spectrum and the second phase spectrum may be indicative of the system delay.

For example, the precise amount of the system delay may be estimated from the difference between the phase spectrum of the minimum phase system (e.g., estimated from the Hilbert transform relations) and the phase spectrum of the compound system (e.g., estimated from the argument of the cross-spectrum, directly from the input-output data).

For example, the method (e.g., in the first and/or second mode) may be applied when the output data is noise affected or the output data is very noisy (e.g., where there are measurement errors). In this case, the output data may only with low accuracy represent or be indicative for the system delay. For example, by analyzing the noisy output data and the input data, it may be difficult according to conventional procedures to determine the delay introduced by the system. However, when the extreme of the objective function is found, the delay may also be determined in the case where the output data is relatively noisy.

According to an embodiment, the first phase spectrum and second phase spectrum is determined only at dominant frequencies. The first system input signal represented in a frequency space includes amplitudes at the dominant frequencies that are higher than a threshold. The threshold is, for example, between 0.3 and 0.8 of a highest amplitude of the first system input data when represented in the frequency space.

Dominant frequencies may represent frequencies that have high amplitudes in the first system input signal when the first system input signal is represented in frequency space or Fourier space.

Frequencies other than the dominant frequencies may have little influence on the determination of the delay, since associated amplitudes of the first system input data may be relatively low. By restricting the frequencies at the dominant frequencies, computational efforts may be reduced without sacrificing much of the achievable accuracy of the determination of the delay.

According to an embodiment, the second phase spectrum at a first frequency is computed as a sum of a logarithm of the absolute value of the estimated transfer function at a second frequency multiplied by a sum of two trigonometric functions each depending on the first frequency and the second frequency. The sum runs across the second frequency (e.g., only including the dominant frequencies).

The sum may run across discrete or continuous frequencies. When the input data and/or the output data are periodic, the input data and/or output data may be expanded in a Fourier sum including discrete frequencies or frequencies at discrete positions that may be integer multiples of a basic frequency, such as the oscillation frequency of the input data. Thereby, the method may be simplified. The trigonometric functions may, for example, be the cot-function. The second phase spectrum estimate may be computed by taking the Hilbert transform of the amplitude spectrum obtained from the input-output data. This may provide an estimate of the phase spectrum that includes no effects of the time delay of the system.

According to an embodiment, finding the extreme includes varying the delay across a range of values, where prior knowledge is used for defining the range of values.

Since the delay is found by direct evaluation of a cost function for a range of values, the range may be chosen, for example, between zero and a delay value much larger than the expected value.

According to an embodiment, the objective function includes a sum of a trigonometric function having an argument depending on a difference between the first phase spectrum and the second phase spectrum at a particular frequency. The sum runs across different frequencies (e.g., only including the dominant frequencies).

The trigonometric function within the objective function may, for example, be the cos-function or the sin-function. The argument of the trigonometric function may include three terms (e.g., the cos of the phase of the estimated transfer function, the second phase spectrum, and the delay times the considered frequency). Thereby, the method may be easily implemented and simplified.

According to an embodiment, the argument is given by the difference between the first phase spectrum and the second phase spectrum, from which the frequency multiplied by the delay is subtracted. This may stem from the fact that the phase spectrum estimated directly from the data includes time delay information, while the phase estimate obtained from the Hilbert transform of the amplitude spectrum may not. Therefore, the difference between these spectral estimates may be the phase contribution from the time delay.

Finding the extreme of the objective function may, for example, include maximizing the objective function (e.g., when the trigonometric function within the objective function is the cos-function).

Thereby, maximizing the objective function and thereby finding the delay may be simplified.

According to an embodiment, the different frequencies are within a frequency range defined to be between 0.2 and 1.0 times a basic frequency of the input data produced by the relay controller.

The frequency range may be the frequency range provided by the Fourier transform (e.g., from 0 to half of the sampling frequency of the data).

For example, the objective function may be evaluated at at least one frequency (e.g., a main frequency of the dominant frequencies). Evaluating the objective function at more than one frequency may improve or enhance the accuracy of the determination of the delay.

According to an embodiment, in the sum, frequencies at which amplitudes of the Fourier transformed input data are lower than a threshold are weighted lower than frequencies at which amplitudes of the Fourier transformed input data are higher than the threshold.

Thereby, a simple scheme for selecting frequencies that may simplify evaluation and maximizing the objective function may be provided.

According to an embodiment, a weighting of different summands in the sum of differences is based on coherence functions. Weighting the different summands may also improve the accuracy of the method.

According to an embodiment, estimating the transfer function includes determining a first function as a Fourier transform of a cross-correlation between the input data and the output data, determining a second function as a square of a Fourier transform of the input data, and computing the estimated transfer function as being proportional to the first function divided by the second function.

The cross-correlation between the input data and the output data may be an integral of a product. The product includes the input data and shifted (e.g., in time) output data. Thereby, estimating the transfer function may be enabled and simplified.

According to an embodiment, the relay controller receives the system output data and produces an output signal that flips between two states. The states are switches when the received system output changes sign (or crosses a border or a particular nominal output value).

The output signal of the relay controller may flip between the two states when the received first system output crosses a nominal system output (e.g., zero). For example, the relay controller may produce a square wave signal that may be supplied to the system, and the system may output first system output data varying according to a smooth curve, such as a curve close or similar to a sine curve or a cosine curve. For example, the first system output data may at least oscillate between an upper and a lower limit value and may, for example, cross a line in the middle between the upper limit value and the lower limit value. For example, this line in the middle between the upper limit value and the lower limit value may represent a nominal (or mean or average) output value. The relay controller (e.g., first controller) may switch e.g., output (e.g., supplied to the system) when the output data crosses the line between the upper limit value and the lower limit value of the output data.

Features that have been disclosed, described, applied to or employed for a method for determining a performance measure may also be applied to an arrangement for determining a performance measure according to an embodiment and vice versa.

According to an embodiment, an arrangement for determining a performance measure of a second controller adapted to control a system is provided. The method includes an input section adapted to obtain first system input data and first system output data, while a first controller receives the first system output data and supplies first controller output to the system as the first system input data. The first controller includes a relay controller and a processor configured to estimate a system delay between the first system input data and the first system output data using a Hilbert transform relations method based on the first system input data and the first system output data. The input section is further adapted to obtain second system output data, while the second controller receives a difference between second system output data and reference data and supplies second controller output to the system as second system input data. The processor is further configured to estimate a minimum system output variance based on the estimated system delay and an impulse response of the system and to estimate the performance measure based on the estimated minimum system output variance and a variance of the second system output data.

The technical system may be any technical system that receives a first/second system input signal (e.g., an electrical and/or optical and/or wireless signal; used for controlling an actuator of the system such as a pump, a heater, a compressor, a motor, etc.) and generates a first/second system output signal, such as a pressure value, a flow rate value, a temperature value or the like. The first/second system input data may be represented by an electrical and/or optical signal or by an electromagnetic wave.

The arrangement or the processor may, for example, include a circuit (e.g., a semiconductor) that may, for example, be programmable, using a conventional computer language, such as C, C++, JAVA, Perl, Python or the like.

The arrangement may, in the first configuration, be connected for obtaining the first system input data to the first controller (e.g., relay controller) and may be connected for obtaining the first system output data to a system output terminal. The arrangement may, in the second configuration, be connected for obtaining the second system input data to the second controller and may be connected for obtaining the second system output data to a system output terminal.

The processor may perform all kinds of computations, including Fourier transformation, Laplace transformation, z-transformation, cross-correlation, maximizing procedures, summation methods and so on. The found system delay may be output and/or may be stored in an electronic storage. Further, based on the determined delay, other tuning parameters of the controller that may be designed for controlling the system may then be determined using the processor.

Any a priori information on the system delay may be useful for the system identification procedures. The accurate value of the time delay may be important to estimate minimum variants and thereby Harris index. Based on the value of the Harris index, poorly performing control loops may be identified and immediately considered for route course diagnosis. Although relay-based auto tuning methods are in practice, the data obtained from this has not been used for ranking of control loops. According to an embodiment, a tool for performance assessment of control loops may be developed by knowing the value of the time delay.

Embodiments have been described with reference to different subject matters. For example, some embodiments have been described with reference to a method, whereas other embodiments have been described with reference to an apparatus. However, a person skilled in the art will gather from the above and the following description that, unless otherwise noted, in addition to any combination of features belonging to one type of subject matter, any combination between features relating to different subject matters (e.g., between features of the method and features of the apparatus) is considered as to be disclosed with this document.

The aspects defined above and further aspects are apparent from the examples of embodiments to be described hereinafter and are explained with reference to the examples of embodiments. The invention will be described in more detail hereinafter with reference to examples but to which the invention is not limited.

### BRIEF DESCRIPTION OF THE DRAWINGS

FIG. 1 schematically illustrates a block diagram of a method for determining a performance measure of a controller according to an embodiment;

FIG. 2 schematically illustrates a first configuration for obtaining first system input data and first system output data as used in the method illustrated in FIG. 1;

FIG. 3 schematically illustrates a second configuration for obtaining second system output data to be used in the method as illustrated in FIG. 1; and

FIG. 4 schematically illustrates one embodiment of an arrangement for determining a performance measure of a controller configured to carry out a method for determining a performance measure of a controller.

### DETAILED DESCRIPTION

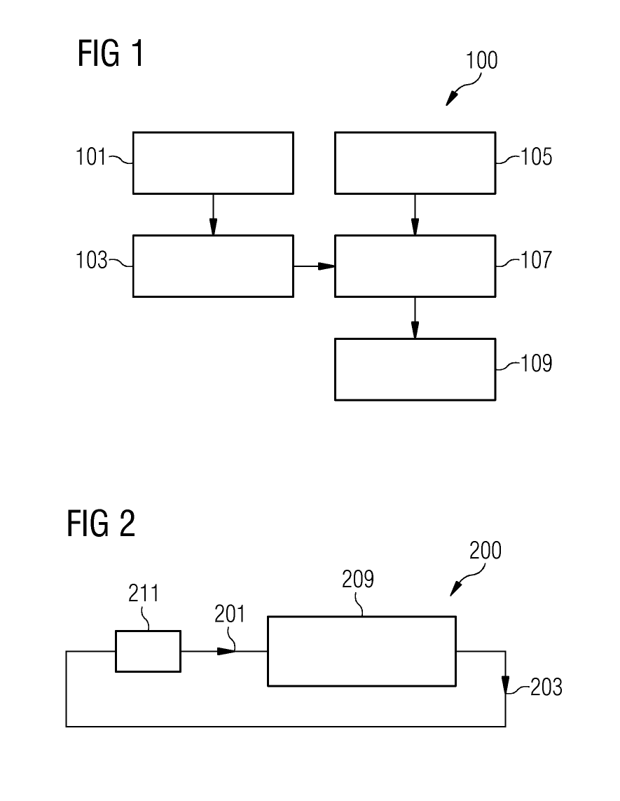

FIG. 1 illustrates a block diagram of a method 100 for determining a performance measure of a controller according to an embodiment. In act 101, in a first mode or first configuration, first system input data and first system output data are obtained under relay-based tune mode (e.g., when a relay controller is arranged upstream of a system to be controlled, as is illustrated in FIG. 2).

For example, in this first configuration in act 101, a first controller (e.g., including a relay controller) receives the first system output data and supplies first controller output to the system as the first system input data.

The first system input data and the first system output data are later used during act 103 to estimate a system delay D between the first system input data and the first system output data using a Hilbert transform relations method. The Hilbert transform relations method uses or is based on the first system input data and the first system output data having been collected in act 101.

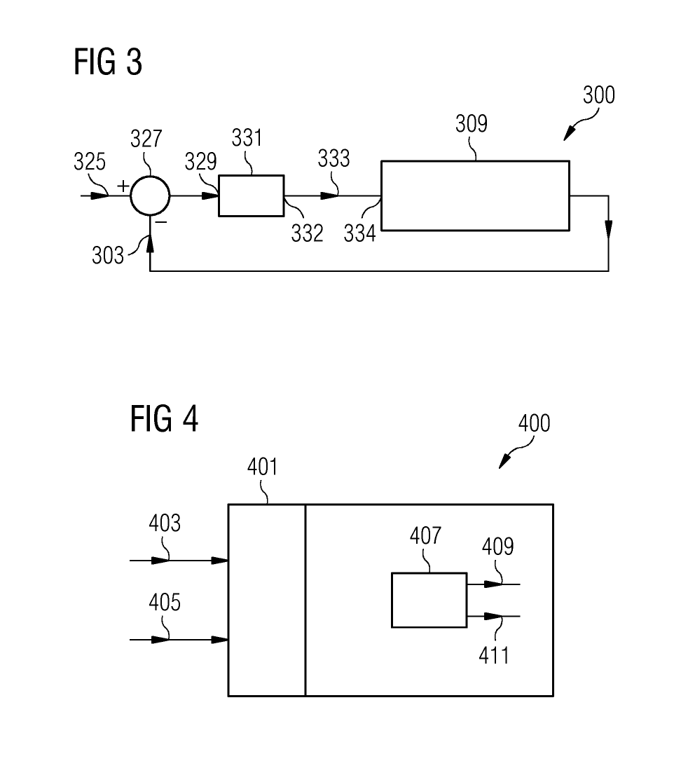

In act 105, in a second mode or second configuration, as is, for example, illustrated in FIG. 3, second system output data (and optionally second system input data) are obtained under routine operating conditions (e.g., while the second controller receives a difference between second system output data and reference data and supplies second controller output to the system as second system input data). For example, the second system output data is later, in act 109, used to calculate an actual variance of the second system output data. In between acts 105 and 109 is act 107, which estimates, based on the estimated system delay estimated in act 103, and also based on an impulse response of the system, minimum system output variance. For example, in act 107, a higher order autoregressive model may be fit to the impulse response of the system, and a minimum variance (e.g., minimum system output variance) is estimated using the time delay. For example, the minimum variance is determined or computed using the following equation

$${σ}_{MV}^{2} = {\sum }_{i = 0}^{τ - 1} {e}_{i}^{2} {σ}_{ɛ}^{2}$$

Thus, the minimum variance estimate is found by analyzing an impulse response, where τ is the system time delay between input (u) and output (y) of the system.

Thereby, the first coefficient of the impulse response e₀ is normalized to unity. The estimate of the actual output variance σ_{y}², may be directly estimated from the collected output samples (e.g., collected in act 105) using the standard relation for the variance. From the minimum variance estimate and the actual output variance, the Harris index η may be found according to the following equation

η=σ_{MV}²/σ_{y}²

where σ_{MV}² is obtained using the minimum variance controller applied to an estimated time series model from measured output data, and σ_{y}² is the actual system output variance.

FIG. 2 illustrates an exemplary first configuration or first mode, in order to collect the process first input/output data under relay-based tune mode in act 101 illustrated in FIG. 1.

A relay controller 211 that produces first controller output 201 that is provided to the system 209 as the first system input data is arranged upstream of the system 209. The system 209 outputs first system output data 203 that is supplied as input to the relay controller 211.

FIG. 3 schematically illustrates a second configuration, in order to collect second input/output data under routine operating conditions, as is performed in act 105 illustrated in FIG. 1.

The second controller 331 thereby controls the system 309. The system 309 outputs second system output data 303, while the second controller 331 receives a difference 329 between second system output data 303 and reference data 325. The difference 329 is obtained using a subtraction element 327.

The second controller 331 outputs second controller output 333 that is supplied to the system 309 as second system input data 334. For example, the second system output data 303 may then be used to estimate an actual variance σ_{y}²of the second system output data 303 used to calculate the Harris index η, as is defined above.

FIG. 4 schematically illustrates an arrangement 400 for determining a performance measure according to an embodiment. The arrangement 400 includes an input section 401 that is adapted to obtain first system input data and first system output data collectively labeled with reference sign 403 (e.g., the first system output data 203 illustrated in FIG. 2).

The input section 401 is further configured to obtain second system output data 405 (e.g., the second system output data 303, as illustrated in FIG. 3).

The arrangement 400 further includes a processor 407 configured to estimate a system delay τ (409) between the first system input data and the first system output data using a Hilbert transform relations method based on the first system input data and the first system output data, as in act 103 illustrated in FIG. 1. The processor 407 is further configured to estimate a minimum system output variance, such as the quantity σ_{MV}²as defined above based on the estimated system delay τ (also referred to as D) and an impulse response of the system (e.g., system 209, 309 illustrated in FIGS. 2 and 3, respectively).

Further, the processor 407 is configured to estimate the performance measure 411 (e.g., η as defined above) based on the estimated minimum system output variance σ_{MV}²and a variance σ_{y}²of the second system output data. The performance measure 411 may, for example, be output from the arrangement 400.

The coefficients of the impulse response may, for example, be obtained using the following formula

Ψ(z⁻¹)=(1+ψ₁z⁻¹+ψ₂z⁻²+ . . . )=C(z⁻¹)/A(z⁻¹)

The coefficients eᵢ are denoted as ψ₁, and z is the coordinate in the z-space. The fitting may be performed in the z-space (e.g., the space of the z-transform).

One or more of the present embodiments may allow estimating the performance of a controller in an effective manner.

The term “comprising” does not exclude other elements or steps, and “a” or “an” does not exclude a plurality. Elements described in association with different embodiments may be combined.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for determining a performance measure of a first controller configured to control a system, the method comprising:
obtaining first system input data and first system output data, while a second controller receives the first system output data and supplies second controller output to the system as the first system input data, the second controller comprising a relay controller;
estimating a system delay between the first system input data and the first system output data using a Hilbert transform relations method based on the first system input data and the first system output data;
obtaining second system output data, while the first controller receives a difference between second system output data and reference data and supplies first controller output to the system as second system input data;
estimating a minimum system output variance based on the estimated system delay and an impulse response of the system; and
estimating the performance measure based on the estimated minimum system output variance and a variance of the second system output data.

2. The method of claim 1, wherein the performance measure comprises a Harris Index as a ratio between the estimated minimum system output variance and the variance of the second system output data.

3. The method of claim 1, wherein estimating the minimum system output variance comprises:
obtaining impulse response coefficients, the obtaining of the impulse response coefficients comprising fitting an autoregressive model to the impulse response of the system;
summing squares of the impulse response coefficients up to a coefficient associated with the estimated system delay.

4. The method of claim 1, wherein the impulse response is obtained by supplying an impulse input as input to the system.

5. The method of claim 4, wherein the impulse input is in the form of a delta peak.

6. The method of claim 1, wherein the Hilbert transform relations method comprises:
estimating from the second input data and the second output data a transfer function associated with the system, the transfer function describing an effect of the system on the second input data to result in the second output data;
determining a first phase spectrum as a phase of the estimated transfer function;
determining a second phase spectrum based on an absolute value of the estimated transfer function; and
obtaining the system delay, the obtaining of the system delay comprising finding an extreme of an objective function, the objective function depending on a difference between the first phase spectrum and the second phase spectrum.

7. The method of claim 6, wherein first phase spectrum and the second phase spectrum are determined only at dominant frequencies, and
wherein the input signal represented in a frequency space comprises amplitudes at the dominant frequencies that are higher than a threshold.

8. The method of claim 7, wherein the threshold is between 0.3 and 0.8 of a highest amplitude of the input data when represented in the frequency space.

9. The method of claim 6, wherein the second phase spectrum at a first frequency is computed as a sum of a logarithm of the absolute value of the estimated transfer function at a second frequency multiplied by a sum of two trigonometric functions each depending on the first frequency and the second frequency, the sum running across the second frequency, only comprising the dominant frequencies.

10. The method of claim 6, wherein finding the extreme comprises varying the system delay across a range of values, and
wherein prior knowledge is used for defining the range of values.

11. The method of claim 6, wherein the objective function comprises a sum of a trigonometric function having an argument depending on a difference between the first phase spectrum and the second phase spectrum at a particular frequency, the sum running across different frequencies, only comprising the dominant frequencies.

12. The method of claim 11, wherein, in the sum, frequencies at which amplitudes of the Fourier transformed input data are lower than a threshold are weighted lower than frequencies at which amplitudes of the Fourier transformed input data are higher than the threshold.

13. The method of claim 6, wherein estimating the transfer function comprises:
determining a first function as a Fourier transform of a cross-correlation between the second input data and the second output data;
determining a second function as a square of a Fourier transform of the second input data; and
computing the estimated transfer function as being proportional to the first function divided by the second function.

14. The method of claim 1, wherein the relay controller receives the first system output data and produces second controller output that flips between two states, and
wherein the states switch when the received first system output data changes sign.

15. An arrangement for determining a performance measure of a first controller configured to control a system, the arrangement comprising:
an input section configured to obtain first system input data and first system output data, while a second controller receives the first system output data and supplies second controller output to the system as the first system input data, the first controller comprising a relay controller;
a processor configured to estimate a system delay between the first system input data and the first system output data using a Hilbert transform relations method based on the first system input data and the first system output data,
wherein the input section is further configured to obtain second system output data, while the first controller receives a difference between the second system output data and reference data and supplies first controller output to the system as second system input data;
wherein the processor is further configured to:
estimate a minimum system output variance based on the estimated system delay and an impulse response of the system; and
estimate the performance measure based on the estimated minimum system output variance and a variance of the second system output data.
